(19) United States
(12) Patent Application Publication
(10) Pub. No.: US 2026/0135140 A1
(43) Pub. Date: May 14, 2026

(54) ION-ELECTRON MIXED CONDUCTOR CERAMIC AND SOLID-STATE ELECTROLYTE, PREPARATION METHODS THEREFOR, AND BATTERY

(71) Applicant: Tsinghua Shenzhen International Graduate School, Shenzhen (CN)

(72) Inventors: Yanbing HE, Shenzhen (CN); Jinshuo MI, Shenzhen (CN); Ming LIU, Shenzhen (CN); Likun CHEN, Shenzhen (CN); Jiabin MA, Shenzhen (CN); Jie BIAO, Shenzhen (CN); Ke YANG, Shenzhen (CN); Xufei AN, Shenzhen (CN); Yuhang LI, Shenzhen (CN); Shaoke GUO, Shenzhen (CN); Cuicui WANG, Shenzhen (CN); Wei LV, Shenzhen (CN); Feiyu KANG, Shenzhen (CN)

(21) Appl. No.: 19/443,211

(22) Filed: Jan. 8, 2026

Related U.S. Application Data
(63) Continuation of application No. PCT/CN2023/124557, filed on Oct. 13, 2023.

(30) Foreign Application Priority Data
Sep. 18, 2023 (CN) 202311201933.2

(51) Int. Cl. H01M 10/056; C01G 25/00; C01G 35/00; H01M 4/62

(52) U.S. Cl. CPC H01M 10/056; C01G 25/006; C01G 35/006; H01M 4/62; C01P 2002/72; C01P 2004/03; C01P 2004/84; C01P 2006/40; H01M 2300/0071; H01M 2300/0082; H01M 2300/0091

(57) ABSTRACT

An ion-electron mixed conductor ceramic comprises Ag-modified LLZTO ceramic; a preparation method of the ion-electron mixed conductor ceramic includes the following steps: adding LLZTO ceramic into a solution containing a soluble silver salt and a reducing agent to obtain silver oxide, and reacting the silver oxide under the action of the reducing agent to prepare the Ag-modified LLZTO ceramic; a composite solid electrolyte comprises the aforementioned ion-electron mixed conductor ceramic, a lithium salt and a polymer; a battery electrode material comprises the aforementioned ion-electron mixed conductor ceramic; a battery comprises the aforementioned ion-electron mixed conductor ceramic or the aforementioned solid electrolyte; when the modified ceramic is applied in electrode materials, it can simultaneously play a role in transporting electrons and ions, improve electrode kinetics, and has good application prospects in the battery field.

### CROSS REFERENCE TO RELATED APPLICATIONS

This application is a continuation application of PCT/CN2023/124557 filed on 2023 Oct. 13, which claims priority to CN patent application NO. CN202311201933.2 filed on 2023 Sep. 18. The contents of the above-mentioned applicationsare all hereby incorporated by reference.

### TECHNICAL FIELD

The present invention relates to battery technology, and in particular to an ion-electron mixed conductor ceramic, a solid electrolyte, as well as their preparation methods and a battery.

### BACKGROUND

Compared with lead-acid batteries and other types of batteries, lithium-ion batteries (LIBs) have the advantages of low self-discharge rate, no memory effect, high energy density, and long cycle life, thus being widely used in various fields such as consumer electronics, energy storage, and new energy. With the proposal of the “dual carbon” policy (carbon peaking and carbon neutrality), the new energy field has entered a new stage of development. Electric vehicles (EVs) are in urgent need of batteries with higher safety and longer cruising range; therefore, lithium-ion batteries (LIBs) are developing towards the direction of higher energy density, longer service life, and better safety. However, the capacity of current traditional graphite anodes has been close to the theoretical limit, which restricts the further improvement of the energy density of lithium batteries. Lithium metal and NCM811 (a nickel-cobalt-manganese ternary cathode material) have high theoretical capacities of 3860 mA·h·g⁻¹ and over 200 mA·h·g⁻¹ respectively, and are regarded as one of the most promising anode and cathode materials for achieving high energy density. Nevertheless, liquid lithium-ion batteries prepared by matching them with organic liquid electrolytes have many shortcomings such as severe interface reactions and poor safety, which limit their practical application. For example, the growth of lithium dendrites may cause battery short circuits, thermal runaway, and even explosions; severe interface side reactions lead to rapid capacity fading, etc. Theoretically, all-solid-state lithium-ion batteries (ASSLBs) with high energy density and safety are the most promising alternatives to liquid lithium-ion batteries.

Solid polymer electrolytes (SPEs) are one of the most widely studied solid electrolytes due to their advantages of high elasticity and plasticity, good electrode compatibility, and ease of preparation. However, many problems such as poor mechanical properties and low ionic conductivity limit their practical application. For instance, polymers like polyethylene oxide (PEO) have a low dielectric constant, which cannot promote the dissociation of lithium salt cation-anion pairs in the electrolyte, resulting in low room-temperature ionic conductivity that fails to meet daily application needs. Meanwhile, PEO has a low oxidation resistance window and cannot be matched with high-voltage cathodes represented by NCM811. Solid electrolytes based on polyvinylidene fluoride (PVDF) have higher oxidation resistance and thermal stability, endowing them with greater prospects for practical application. However, PVDF-based solid electrolytes still face issues including low mechanical strength, relatively low dielectric constant, and insufficient ionic conductivity and lithium-ion transference number, which lead to poor battery rate performance and short cycle life.

It should be noted that the information disclosed in the above background art section is only for understanding the background of the present application, and thus may include information that does not constitute the prior art known to those of ordinary skill in the art.

### SUMMARY

The main objective of the present invention is to overcome the defects in the aforementioned background art and provide an ion-electron mixed conductor ceramic, a solid electrolyte, as well as their preparation methods and a battery.

To achieve the above objective, the present invention adopts the following technical solutions:

An ion-electron mixed conductor ceramic comprises silver (Ag)-modified LLZTO ceramic.

Further, the LLZTO is Li_{6.5}La₃Zr_{1.5}Ta_{0.5}O₁₂, Li₇La₃Zr₂O₁₂, or a doped derivative ceramic thereof.

A preparation method of the ion-electron mixed conductor ceramic comprises the following steps:
Adding LLZTO ceramic into a solution containing a soluble silver salt and a reducing agent to obtain silver oxide;
Reacting the silver oxide under the action of the reducing agent to prepare the Ag-modified LLZTO ceramic.

Further, the soluble silver salt is one of silver nitrate (AgNO₃), silver chlorate (AgClO₃), and silver perchlorate (AgClO₄).

Further, the reducing agent is one of ethanol, sulfurous acid, sodium sulfite, and hydrogen peroxide.

A composite solid electrolyte comprises the aforementioned ion-electron mixed conductor ceramic, a lithium salt, and a polymer.

Further, the lithium salt is one of lithium bis(fluorosulfonyl)imide, lithium bis(trifluoromethanesulfonyl)imide, lithium hexafluorophosphate, and lithium tetrafluoroborate; the polymer is one of polyethylene oxide (PEO), polyvinylidene fluoride (PVDF), and polyvinylidene fluoride-hexafluoropropylene (PVDF-HFP).

A preparation method of the solid electrolyte comprises mixing the polymer, the lithium salt, and the ion-electron mixed conductor ceramic in a predetermined proportion uniformly to prepare the solid electrolyte.

A battery electrode material comprises the aforementioned ion-electron mixed conductor ceramic.

A battery comprises the aforementioned ion-electron mixed conductor ceramic or the aforementioned solid electrolyte.

The present invention has the following beneficial effects:

The present invention provides an Ag-modified LLZTO (LLZTO@Ag) ion-electron mixed conductor ceramic. This LLZTO@Ag composite ceramic has both ionic conductivity and electronic conductivity. The composite solid electrolyte formed by combining this modified ceramic with polyvinylidene fluoride (PVDF) exhibits high dielectric constant, high ionic conductivity, and high lithium-ion transference number. The battery assembled by matching it with a lithium metal anode and an NCM811 cathode has excellent cycle stability at room temperature and can still maintain a high capacity after multiple cycles. When this modified ceramic is applied in electrode materials, it can simultaneously transport electrons and ions, improve electrode kinetics, and has good application prospects in the battery field.

The present invention provides a preparation method for the Ag-modified LLZTO (LLZTO@Ag) ion-electron mixed conductor ceramic. Silver ions react with residual alkali on the surface of LLZTO to generate silver oxide, and the silver oxide is further reduced to metallic silver in the presence of a reducing agent. The LLZTO@Ag ceramic particles are obtained by drying the solvent. The preparation method provided by the present invention is simple, has mild reaction conditions and low cost, and possesses strong adaptability and universality. The prepared LLZTO@Ag ceramic can be used to prepare composite solid electrolytes, so as to improve the ionic conductivity and mechanical strength of the solid electrolytes.

The composite solid electrolyte provided by the present application has a high dielectric constant, and exhibits high lithium salt dissociation degree, high ionic conductivity, and high lithium-ion transference number. It can be well matched with lithium metal anodes and NCM811 cathodes, has good rate performance under high current and excellent cycle stability, and thus has high application value.

Other beneficial effects of the embodiments of the present invention will be further described in the following content.

### BRIEF DESCRIPTION OF THE DRAWINGS

FIG. 1 shows the chemical reaction equations in the preparation process of the Ag-modified Li_{6.5}La₃Zr_{1.5}Ta_{0.5}O₁₂ (LLZTO@Ag) ion-electron mixed conductor ceramic in Example 1;

FIG. 2 shows the X-ray diffraction (XRD) phase structure diagram of the LLZTO@Ag material prepared in Example 1;

FIG. 3 shows the scanning electron microscopy (SEM) morphology and element distribution diagram of the LLZTO@Ag material prepared in Example 1;

FIG. 4 shows the surface and cross-sectional SEM images of the composite solid electrolyte prepared in Example 2;

FIG. 5 shows the surface SEM image of the PVL solid electrolyte membrane prepared in Comparative Example 1;

FIG. 6 shows the optical photograph of the PVLA solid electrolyte membrane prepared in Example 2 (a) and the optical photograph of the PVL solid electrolyte prepared in Comparative Example 1 (b);

FIG. 7 shows the tensile test diagram of the solid electrolytes prepared in Comparative Example 1 and Example 2;

FIG. 8 shows the dielectric constant test diagram of the solid electrolytes prepared in Comparative Example 1 and Example 2;

FIG. 9 shows the ionic conductivity of the solid electrolytes prepared in Comparative Example 1 and Example 2;

FIG. 10 shows the lithium-ion transference number test diagram of the solid electrolytes prepared in Comparative Example 1 and Example 2;

FIG. 11 shows the rate performance test curve of the full cells based on PVLA and PVL composite solid electrolyte membranes prepared in Example 3;

FIG. 12 shows the cycle performance test curve of the full cells based on PVLA and PVL composite solid electrolyte membranes prepared in Example 3;

FIG. 13 shows the long-cycle test curve of the Li—Li symmetric cells based on PVLA and PVL composite solid electrolyte membranes prepared in Example 3.

### DETAILED DESCRIPTION

The technical solutions in the embodiments of the present invention will be clearly and completely described below in conjunction with the drawings in the embodiments of the present invention. Obviously, the described embodiments are only a part of the embodiments of the present invention, rather than all the embodiments. Based on the embodiments of the present invention, all other embodiments obtained by those of ordinary skill in the art without making creative work shall fall within the protection scope of the present invention.

Unless otherwise defined, all technical and scientific terms used herein have the same meanings as commonly understood by those skilled in the technical field of the present invention. The terms used in the description of the present invention herein are only for the purpose of describing specific embodiments, and are not intended to limit the present invention.

Embodiments of the present invention provide an ion-electron mixed conductor ceramic, which comprises silver (Ag)-modified LLZTO ceramic (denoted as LLZTO@Ag). The LLZTO refers to Li_{6.5}La₃Zr_{1.5}Ta_{0.5}O₁₂, Li₇La₃Zr₂O₁₂, or their doped derivative ceramics. In the present invention, it is only required that the ion-electron mixed conductor ceramic contains an effective amount of Ag. In some embodiments, the mass ratio of Ag to LLZTO is less than 1.

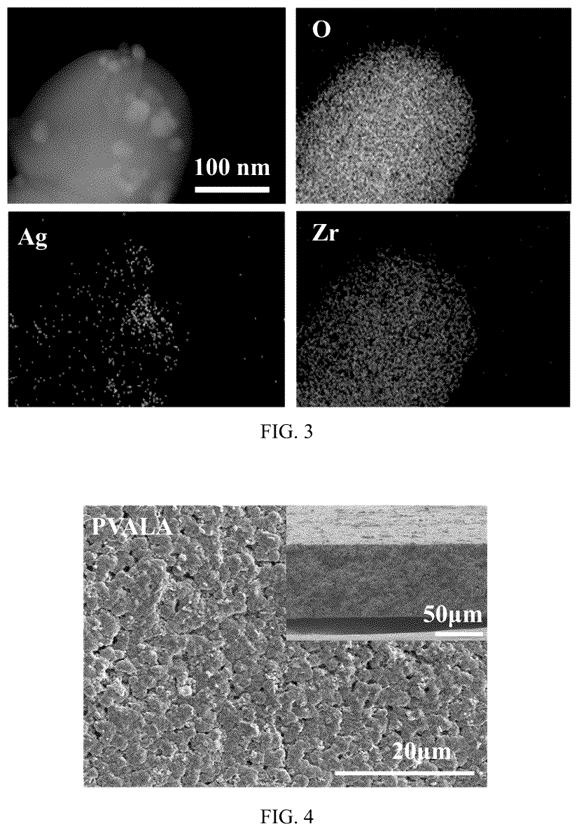

In one embodiment, the phase structure and morphological structure of an Ag-modified Li_{6.5}La₃Zr_{1.5}Ta_{0.5}O₁₂ ion-electron mixed conductor ceramic are as shown in FIG. 2 and FIG. 3.

Embodiments of the present invention also provide a preparation method of the ion-electron mixed conductor ceramic, which includes the following steps:
Adding LLZTO ceramic into a solution containing a soluble silver salt and a reducing agent to obtain silver oxide;
Reacting the silver oxide under the action of the reducing agent to prepare the Ag-modified LLZTO ceramic.

In some embodiments, the molar ratio of silver ions in the silver salt to LLZTO is greater than 2, and the molar ratio of the number of electrons that the reducing agent can participate in redox reactions to silver ions is greater than 1. In some embodiments, a preparation method of the Ag-modified Li_{6.5}La₃Zr_{1.5}Ta_{0.5}O₁₂ ion-electron mixed conductor ceramic includes the following steps:
Adding a soluble silver salt into an ethanol solution for dissolution, then adding Li_{6.5}La₃Zr_{1.5}Ta_{0.5}O₁₂ into the above solution, conducting an in-situ reaction to generate a suspension of LLZTO ceramic particles modified with metallic Ag, and drying the solution to obtain LLZTO@Ag particles.

Among them, silver ions react with residual alkali on the surface of LLZTO to generate silver oxide; the silver oxide is further reduced to metallic silver in the presence of the reducing agent; and the LLZTO@Ag ceramic particles are obtained by drying the solvent.

In some embodiments, the silver salt is selected from one of silver nitrate (AgNO₃), silver chlorate (AgClO₃), and silver perchlorate (AgClO₄).

In some embodiments, the reducing agent is selected from one of ethanol, sulfurous acid, sodium sulfite, and hydrogen peroxide.

A solid electrolyte is prepared from raw materials including the aforementioned LLZTO@Ag ceramic, a lithium salt, and a polymer.

In some embodiments, the lithium salt is selected from one of lithium bis(fluorosulfonyl)imide, lithium bis(trifluoromethanesulfonyl)imide, lithium hexafluorophosphate, and lithium tetrafluoroborate.

In some embodiments, the polymer is selected from one of polyethylene oxide (PEO), polyvinylidene fluoride (PVDF), and polyvinylidene fluoride-hexafluoropropylene (PVDF-HFP).

In some embodiments, the preparation method of the solid electrolyte includes the following steps:
Taking the polymer, the lithium salt, and the modified ceramic, and mixing them uniformly in a certain proportion to prepare the solid electrolyte.

A battery includes the aforementioned Ag-modified LLZTO (LLZTO@Ag) ion-electron mixed conductor ceramic or the aforementioned solid electrolyte.

In some embodiments, the battery is a lithium battery.

In one example, LLZTO (preferably Li_{6.5}La₃Zr_{1.5}Ta_{0.5}O₁₂) is added into an ethanol solution of silver nitrate for an in-situ reaction to generate LLZTO ceramic particles modified with metallic Ag, so that the formed LLZTO@Ag has both ionic conductivity and electronic conductivity.

The composite solid electrolyte formed by combining this modified ceramic with polyvinylidene fluoride (PVDF) exhibits high dielectric constant, high ionic conductivity, and high lithium-ion transference number. The battery assembled by matching it with a lithium metal anode and an NCM811 cathode has excellent cycle stability at room temperature and can still maintain a high capacity after multiple cycles. When this modified ceramic is applied in electrode materials, it can simultaneously transport electrons and ions, improve electrode kinetics, and has good application prospects in the battery field.

The following describes the present invention in detail with reference to specific embodiments.

### EXAMPLE 1

This example provides an Ag-modified Li_{6.5}La₃Zr_{1.5}Ta_{0.5}O₁₂ (LLZTO@Ag) ion-electron mixed conductor ceramic, which is prepared according to the following steps:
Step S1: Add 150 mg of AgNO₃ (silver nitrate) into ethanol and dissolve it completely to obtain an ethanol solution of silver nitrate.
Step S2: Take 200 mg of Li_{6.5}La₃Zr_{1.5}Ta_{0.5}O₁₂, add it into the silver nitrate ethanol solution obtained in Step S1, and stir for 12 hours to ensure sufficient reaction.
Step S3: Let the suspension obtained in Step S2 stand for 2 hours, remove the supernatant, add ethanol, stir for 1 hour for cleaning, let it stand again for 2 hours, and remove the supernatant to obtain a precipitate.
Step S4: Place the precipitate obtained in Step S3 in a blast drying oven at 80° C. and dry it for 12 hours to obtain the Ag-modified Li_{6.5}La₃Zr_{1.5}Ta_{0.5}O₁₂ (LLZTO@Ag) ion-electron mixed conductor ceramic.

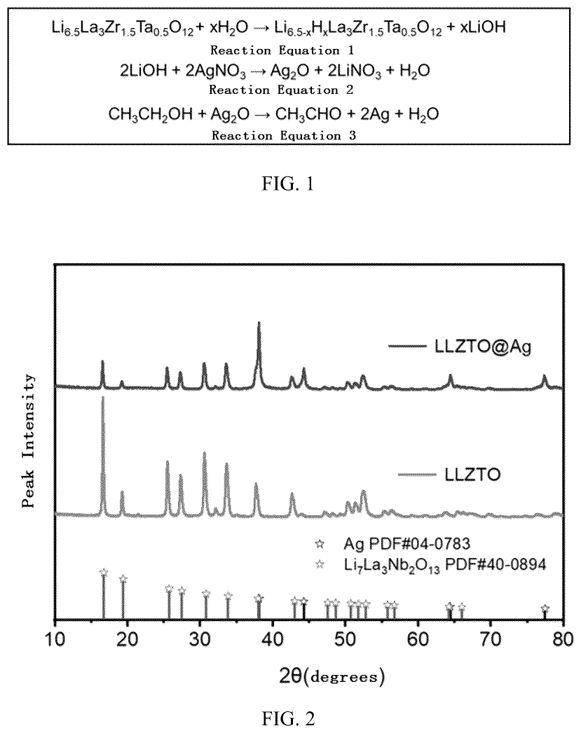

Refer to FIG. 1, which shows the chemical reaction equations in the preparation process of the Ag-modified Li_{6.5}La₃Zr_{1.5}Ta_{0.5}O₁₂ (LLZTO@Ag) ion-electron mixed conductor ceramic in Example 1. It is inevitable that residual alkali is generated on the surface of LLZTO during preparation and storage (Reaction Equation 1). Silver ions react with the residual alkali on the surface of LLZTO to generate silver oxide (Reaction Equation 2), and the silver oxide is further reduced to metallic silver in the presence of a reducing agent (Reaction Equation 3). The LLZTO@Ag ceramic particles are obtained by drying the solvent.

FIG. 2 shows the X-ray diffraction (XRD) phase structure diagram of the LLZTO@Ag material prepared in Example 1. It can be seen that the prepared material has two types of diffraction peaks corresponding to LLZTO and Ag, indicating the presence of two phases, i.e., LLZTO and Ag.

FIG. 3 shows the scanning electron microscopy (SEM) morphology image of the LLZTO@Ag material prepared in Example 1. It can be observed the morphological distribution of the two phases (LLZTO and Ag), specifically that small Ag particles are dispersedly distributed on the surface of large LLZTO particles.

### EXAMPLE 2

This example provides a high-dielectric composite solid electrolyte (PVLA solid electrolyte), which is prepared according to the following steps:
Step S1: First, weigh 267 mg of LiFSI (lithium bis(fluorosulfonyl)imide) in an inert atmosphere, place it in a stirring flask, add 15 mL of DMF (N,N-dimethylformamide), then add 400 mg of PVDF (polyvinylidene fluoride), and stir with a small stirrer at room temperature for more than 2 hours until LiFSI and PVDF are completely dissolved to obtain a uniform transparent solution.
Step S2: Take 200 mg of the LLZTO@Ag obtained in Example 1, add it into the transparent solution obtained in Step S1, and stir at room temperature for more than 6 hours to obtain a uniform black solution.
Step S3: Pour the solution obtained in Step S2 into a glass petri dish, place it in a blast drying oven at 55° C. and dry for 23 hours to remove the excess solvent (DMF), so as to obtain a PVLA composite solid electrolyte membrane. Punch the membrane into an appropriate size and store it in an inert atmosphere for later use after drying.

FIG. 4 shows the surface and cross-sectional SEM images of the composite solid electrolyte prepared in Example 2. It can be seen that the composite solid electrolyte prepared in Example 2 of the present application has a dense surface, uniformly distributed ceramic particles, and a thickness of approximately 80 μm.

### COMPARATIVE EXAMPLE 1

A solid electrolyte is provided, and its preparation process is the same as Step S1 of Example 2. The difference lies in Step S2: 200 mg of untreated Li_{6.5}La₃Zr_{1.5}Ta_{0.5}O₁₂ (LLZTO) is added to the transparent solution obtained in Step S1. After stirring for 6 hours, the resulting solution is poured into a glass vessel, which is then placed in a blast drying oven at 55° C. for 23 hours to remove the excess solvent (DMF), thereby obtaining a PVL composite solid electrolyte membrane. The membrane is punched into an appropriate size and stored in an inert atmosphere for later use after drying.

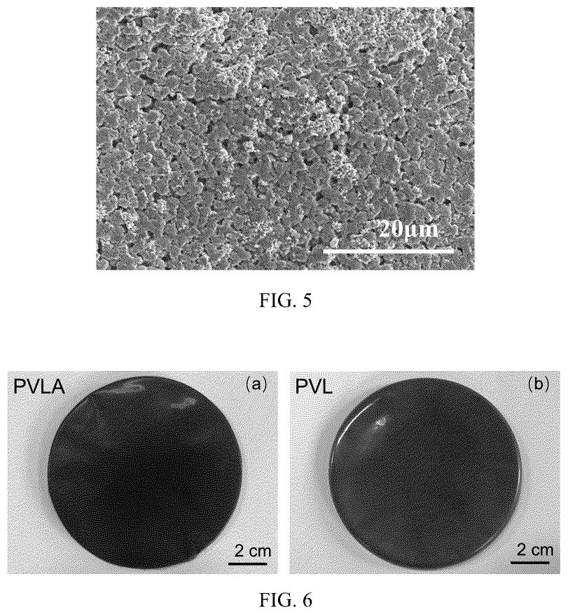

FIG. 5 shows the surface SEM image of the PVL composite solid electrolyte membrane prepared in Comparative Example 1. It can be seen that the composite solid electrolyte prepared in Comparative Example 1 of the present application has a rough surface with relatively large pores, and the ceramic particles are distributed unevenly.

In FIG. 6, (a) shows the optical photograph of the PVLA composite solid electrolyte prepared in Example 2, and (b) shows the optical photograph of the PVL composite solid electrolyte membrane prepared in Comparative Example 1. The PVL solid electrolyte membrane in Comparative Example 1 is brownish-yellow, while the PVLA solid electrolyte obtained in Example 2 of the present application is black, and the electrolyte is flat and dense.

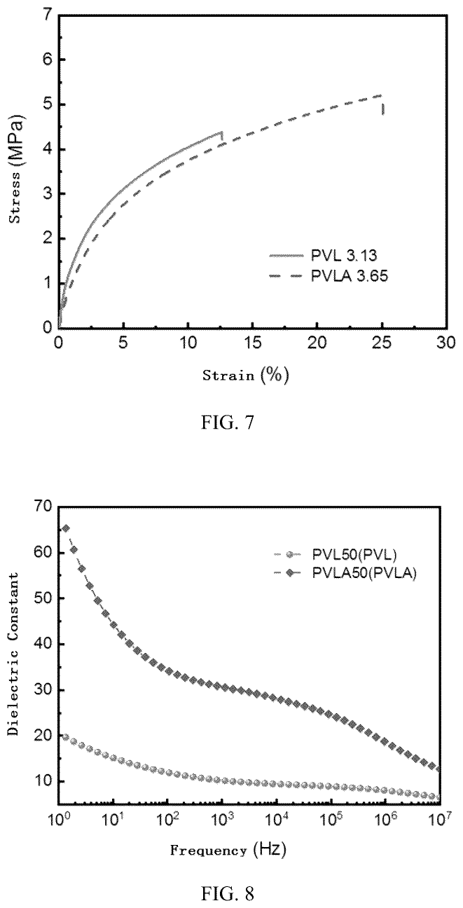

FIG. 7 shows the tensile curves of the PVL composite solid electrolyte membrane prepared in Comparative Example 1 and the PVLA composite solid electrolyte membrane obtained by modification in Example 1. It can be seen that compared with the PVL solid electrolyte membrane (3.1 MPa), the PVLA solid electrolyte membrane exhibits higher tensile strength (3.7 MPa).

Refer to FIG. 8, which shows the dielectric constant test results of the solid electrolytes prepared in Example 2 and Comparative Example 1. The experimental results indicate that after adding 50 wt % of the ion-electron mixed conductor ceramic (LLZTO@Ag), the dielectric constant of the PVLA composite electrolyte is significantly improved, showing a relative dielectric constant of 47 at a frequency of 10 Hz, which is much higher than that of the PVL composite solid electrolyte prepared in Comparative Example 1 (15 ).

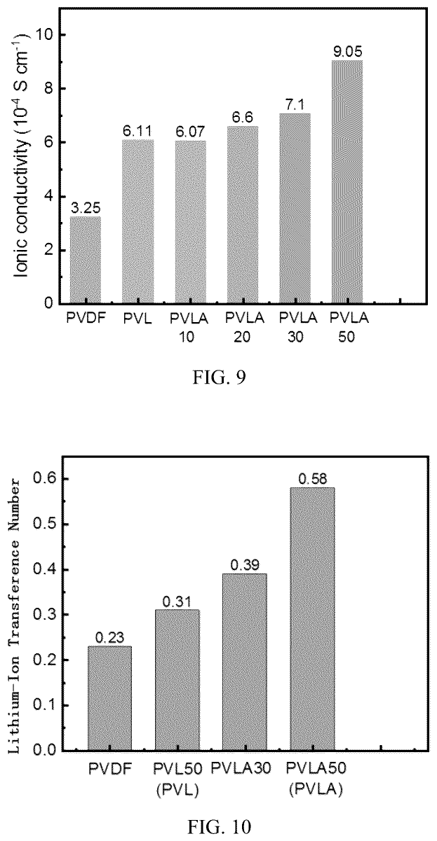

FIG. 9 shows the ionic conductivities of the PVL-based solid electrolyte membrane prepared in Comparative Example 1 and the PVLA solid electrolyte membrane prepared in Example 2. It can be found that due to the significant improvement in dielectric constant, the degree of lithium salt dissociation in the PVLA composite solid electrolyte is increased, resulting in a room-temperature ionic conductivity of 9.05×10⁻⁴ S/cm, which is much higher than the room-temperature ionic conductivity of 6.11×10⁻⁴ S/cm of the PVL-based solid electrolyte in Comparative Example 1.

Refer to FIG. 10, which shows the lithium-ion transference number test results of the solid electrolytes prepared in Comparative Example 1 and Example 2. It can be found that due to the significant improvement in dielectric constant, the degree of lithium salt dissociation in the PVLA composite solid electrolyte is increased, showing a lithium-ion transference number of 0.58, which is much higher than the lithium-ion transference number of 0.31 of the PVL-based solid electrolyte in Comparative Example 1.

### EXAMPLE 3

This example provides a method for assembling a full cell, which is carried out in the following steps:
Step S1: Prepare positive electrode slurry. First, weigh 100 mg of PVDF (as a binder) and place it in a stirring flask. Add 1 mL of NMP (N-methylpyrrolidone) and stir with a small stirrer for 1 hour until the PVDF is completely dissolved. Then add 100 mg of Super P (conductive carbon black) and 1 mL of NMP, stir at room temperature for 1 hour, and then add 800 mg of NCM811 (nickel-cobalt-manganese ternary material) active substance and 1.5 mL of NMP. Stir at room temperature for more than 6 hours.
Step S2: Prepare the positive electrode. Coat the positive electrode slurry obtained in Step S1 on an aluminum foil, dry it at 80° C. for more than 6 hours, cut it into an appropriate size to obtain the NCM811 positive electrode, and store it in a vacuum oven for drying.
Step S3: Prepare the composite solid electrolyte.
Step S4: According to the full cell assembly process, assemble the NCM811 positive electrode prepared in Step S2, the PVLA composite solid electrolyte membrane prepared in Example 2, and the PVL composite solid electrolyte membrane prepared in Comparative Example 1 with lithium metal to form a full cell.
Step S5: According to the symmetric cell assembly process, sandwich the PVLA composite solid electrolyte membrane prepared in Example 2 and the PVL composite solid electrolyte membrane prepared in Comparative Example 1 between two layers of lithium metal to assemble Li—Li symmetric cells.

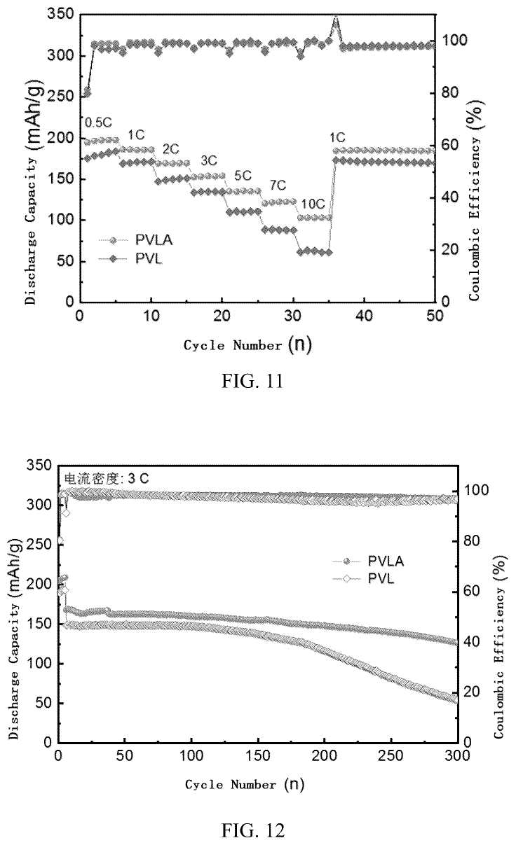

In accordance with the full cell assembly process, full cells based on PVLA and PVL composite solid electrolyte membranes were prepared in this example. FIG. 11 shows the rate performance test curves of the two types of cells. It can be seen from the figure that the full cell assembled by matching PVLA with the NCM811 positive electrode and lithium metal negative electrode can still deliver a capacity of 103 mAh/g at a current density of 10 C at room temperature, which is higher than the 54 mAh/g capacity of the cell with PVL.

FIG. 12 shows the cycle performance test curves of the full cells based on PVLA and PVL composite solid electrolyte membranes. The results show that the full cell assembled by matching PVLA with the NCM811 positive electrode and lithium metal negative electrode can cycle stably for 300 cycles at a current density of 3 C at room temperature, and exhibits higher discharge capacity and stability compared with the cell with PVL.

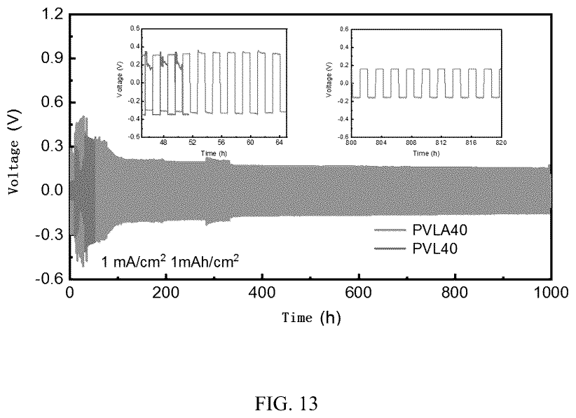

In accordance with the symmetric cell assembly process, Li—Li symmetric cells based on PVLA and PVL composite solid electrolyte membranes were prepared in this example. FIG. 13 shows the Li—Li symmetric test curves of the two types of cells. The results show that the Li—Li symmetric cell assembled by matching PVLA with lithium metal can cycle stably for 1000 hours at a current density of 1 mA/cm² and a deposition capacity of 1 mAh/cm², and exhibits lower polarization voltage and longer cycle life compared with the cell with PVL.

### EXAMPLE 4

This example provides an Ag-modified Li₇La₃Zr₂O₁₂ (LLZO@Ag) ion-electron mixed conductor ceramic, which is prepared according to the following steps:
Step S1: Add 150 mg of AgNO₃ (silver nitrate) into ethanol and dissolve it completely to obtain an ethanol solution of silver nitrate.
Step S2: Take 200 mg of Li₇La₃Zr₂O₁₂, add it into the silver nitrate ethanol solution described in Step S1, and stir for 12 hours to ensure sufficient reaction.
Step S3: Let the suspension obtained in Step S2 stand for 2 hours, remove the supernatant, add ethanol, stir for 1 hour for cleaning, let it stand again for 2 hours, and remove the supernatant to obtain a precipitate.
Step S4: Place the precipitate obtained in Step S3 in a blast drying oven at 80° C. and dry it for 12 hours to obtain the Ag-modified Li₇La₃Zr₂O₁₂ (LLZO@Ag) ion-electron mixed conductor ceramic.

### EXAMPLE 5

This example provides a method for assembling a full cell, which is carried out in the following steps:
Step S1: Prepare positive electrode slurry. First, weigh 100 mg of PVDF (as a binder) and place it in a stirring flask. Add 1 mL of NMP (N-methylpyrrolidone) and stir with a small stirrer for 1 hour until the PVDF is completely dissolved. Then add 100 mg of Super P (conductive carbon black) and 1 mL of NMP, stir at room temperature for 1 hour, and then add 800 mg of NCM811 active substance and 1.5 mL of NMP. Stir at room temperature for more than 6 hours.
Step S2: Prepare the positive electrode. Coat the positive electrode slurry obtained in Step S1 on an aluminum foil, dry it at 80° C. for more than 6 hours, cut it into an appropriate size to obtain the NCM811 positive electrode, and store it in a vacuum oven for drying.
Step S3: Prepare the PVDF-LLZO@Ag composite solid electrolyte:
S31: First, weigh 267 mg of LiFSI (lithium bis(fluorosulfonyl)imide) in an inert atmosphere, place it in a stirring flask, add 15 mL of DMF (N,N-dimethylformamide), then add 400 mg of PVDF, and stir with a small stirrer at room temperature for more than 2 hours until LiFSI and PVDF are completely dissolved to obtain a uniform transparent solution.
S32: Add 200 mg of LLZO@Ag into the solution obtained in Step S31, and stir at room temperature for more than 24 hours to obtain a uniform black solution.
S33: Pour the solution obtained in Step S32 into a glass petri dish, place it in a blast drying oven at 55° C. and dry for 23 hours to remove the excess solvent (DMF), so as to obtain a PVDF-LLZO@Ag composite solid electrolyte membrane. Punch the membrane into an appropriate size and store it in an inert atmosphere for later use after drying.
Step S4: According to the battery assembly process, assemble the NCM811 positive electrode prepared in Step S2, the PVDF-LLZO@Ag-based solid electrolyte membrane prepared in Step S3, and lithium metal to form a full cell.

### EXAMPLE 6

This example provides a method for assembling a full cell, which is carried out in the following steps:
Step S1: Prepare positive electrode slurry. First, weigh 100 mg of PVDF (as a binder) and place it in a stirring flask. Add 1 mL of NMP (N-methylpyrrolidone) and stir with a small stirrer for 1 hour until the PVDF is completely dissolved. Then add 100 mg of Super P (conductive carbon black) and 1 mL of NMP, stir at room temperature for 1 hour, and then add 800 mg of NCM811 active substance and 1.5 mL of NMP. Stir at room temperature for more than 6 hours.
Step S2: Prepare the positive electrode. Coat the positive electrode slurry obtained in Step S1 on an aluminum foil, dry it at 80° C. for more than 6 hours, cut it into an appropriate size to obtain the NCM811 positive electrode, and store it in a vacuum oven for drying.
Step S3: Prepare the PEO-LLZTO@Ag composite solid electrolyte:
S31: First, weigh 267 mg of LiTFSI (lithium bis(trifluoromethanesulfonyl)imide) in an inert atmosphere, place it in a stirring flask, add 15 mL of acetonitrile, then add 400 mg of PEO (polyethylene oxide), and stir with a small stirrer at room temperature for more than 2 hours until LiTFSI and PEO are completely dissolved to obtain a uniform transparent solution.
S32: Add 200 mg of LLZTO@Ag into the solution obtained in Step S31, and stir at room temperature for more than 24 hours to obtain a uniform black solution.
S33: Pour the solution obtained in Step S32 into a glass petri dish, place it in a blast drying oven at 60° C. and dry for 24 hours to remove the solvent (acetonitrile), so as to obtain a PEO-LLZTO@Ag composite solid electrolyte membrane. Punch the membrane into an appropriate size and store it in an inert atmosphere for later use after drying.
Step S4: According to the battery assembly process, assemble the NCM811 positive electrode prepared in Step S2, the PEO-LLZTO@Ag-based solid electrolyte membrane prepared in Step S3, and lithium metal to form a full cell.

### EXAMPLE 7

This example provides a method for assembling a full cell, which is carried out in the following steps:
Step S1: Prepare positive electrode slurry. First, weigh 100 mg of PVDF (as a binder) and place it in a stirring flask. Add 1 mL of NMP (N-methylpyrrolidone) and stir with a small stirrer for 1 hour until the PVDF is completely dissolved. Then add 100 mg of Super P (conductive carbon black) and 1 mL of NMP, stir at room temperature for 1 hour, and then add 800 mg of NCM811 active substance and 1.5 mL of NMP. Stir at room temperature for more than 6 hours.
Step S2: Prepare the positive electrode. Coat the positive electrode slurry obtained in Step S1 on an aluminum foil, dry it at 80° C. for more than 6 hours, cut it into an appropriate size to obtain the NCM811 positive electrode, and store it in a vacuum oven for drying.
Step S3: Prepare the PVDF-HFP-LLZTO@Ag composite solid electrolyte:
S31: First, weigh 267 mg of LiFSI (lithium bis(fluorosulfonyl)imide) in an inert atmosphere, place it in a stirring flask, add 15 mL of DMF (N,N-dimethylformamide), then add 400 mg of PVDF-HFP (polyvinylidene fluoride-hexafluoropropylene), and stir with a small stirrer at room temperature for more than 2 hours until LiFSI and PVDF-HFP are completely dissolved to obtain a uniform transparent solution.
S32: Add 200 mg of LLZTO@Ag into the solution obtained in Step S31, and stir at room temperature for more than 24 hours to obtain a uniform black solution.
S33: Pour the solution obtained in Step S32 into a glass petri dish, place it in a blast drying oven at 60° C. and dry for 24 hours to remove the solvent (DMF), so as to obtain a PVDF-HFP-LLZTO@Ag composite solid electrolyte membrane. Punch the membrane into an appropriate size and store it in an inert atmosphere for later use after drying.
Step S4: According to the battery assembly process, assemble the NCM811 positive electrode prepared in Step S2, the PVDF-HFP-LLZTO@Ag-based solid electrolyte membrane prepared in Step S3, and lithium metal to form a full cell.

### EXAMPLE 8

This example provides a composite positive electrode and a method for assembling a full cell, which is carried out in the following steps:
Step S1: Prepare composite positive electrode slurry. First, weigh 90 mg of PVDF (as a binder) and place it in a stirring flask. Add 1 mL of NMP (N-methylpyrrolidone) and stir with a small stirrer for 1 hour until the PVDF is completely dissolved. Then add 90 mg of Super P (conductive carbon black) and 1 mL of NMP, stir at room temperature for 1 hour, and then add 20 mg of LLZTO@Ag ion-electron mixed conductor ceramic, 800 mg of NCM811 active substance, and 1.5 mL of NMP. Stir at room temperature for more than 6 hours.
Step S2: Prepare the composite positive electrode. Coat the composite positive electrode slurry obtained in Step S1 on an aluminum foil, dry it at 80° C. for more than 6 hours, cut it into an appropriate size to obtain the NCM811 composite positive electrode, and store it in a vacuum oven for drying.
Step S3: Prepare the PVLA composite solid electrolyte according to the method in Example 2.
Step S4: According to the battery assembly process, assemble the NCM811 composite positive electrode prepared in Step S2, the PVLA solid electrolyte membrane prepared in Step S3, and lithium metal to form a full cell.

### Technical Advantages of the Present Invention

The modified ceramic of the present invention solves the problems of low dielectric constant of existing solid electrolytes, difficult dissociation of lithium salts and low ionic conductivity in existing solid electrolytes, and poor rate performance of existing solid electrolytes.

The LLZTO@Ag ceramic particles (ion-electron mixed conductor ceramic) of the present invention have both ionic conductivity and electronic conductivity. This unique property distinguishes it from existing ceramics, enabling it to simultaneously transport electrons and ions. When compounded with polymer electrolytes, it can improve the dielectric properties of the composite electrolyte. Compared with existing polymer solid electrolytes, the composite solid electrolyte of the present invention has the advantages of high dielectric constant, high lithium salt dissociation degree, high ionic conductivity, and high lithium-ion transference number. It also has excellent mechanical properties and can realize operation at high current rates. The production method of the composite solid electrolyte and gradient SEI (solid electrolyte interphase) is simple, which significantly reduces production costs. Moreover, the performance of the solid electrolyte is greatly improved, providing obvious technical and cost advantages.

Under the premise of a cost similar to that of conventional solid electrolytes, the solid electrolyte of the present invention has higher dielectric constant, ionic conductivity, and lithium-ion transference number. It can simultaneously solve the problems of difficult lithium salt dissociation, low ionic conductivity, and poor ability to resist lithium dendrite growth in electrolytes, thereby realizing stable operation of batteries at high current rates. Conventional composite electrolytes cannot simultaneously balance ionic conductivity, interface stability, and other properties. The present invention can solve safety issues such as fire and explosion caused by batteries using conventional liquid electrolytes, and has high research value and application prospects.

The background section of the present invention may contain background information about the problems or environment related to the present invention, and is not necessarily intended to describe the prior art. Therefore, the content included in the background section shall not be deemed as an admission by the applicant that such content constitutes prior art.

The above content is a further detailed description of the present invention in combination with specific/preferred embodiments, and it shall not be considered that the specific implementation of the present invention is limited to these descriptions. For those of ordinary skill in the technical field to which the present invention belongs, without departing from the concept of the present invention, they can also make several substitutions or modifications to the described embodiments, and these substitutions or modifications shall all be regarded as falling within the protection scope of the present invention. In the description of this specification, references to terms such as “one embodiment”, “some embodiments”, “preferred embodiments”, “examples”, “specific examples”, or “some examples” mean that specific features, structures, materials, or characteristics described in connection with the embodiment or example are included in at least one embodiment or example of the present invention. In this specification, the schematic descriptions of the above terms are not necessarily directed to the same embodiment or example. Furthermore, the described specific features, structures, materials, or characteristics may be combined in any suitable manner in any one or more embodiments or examples. Those skilled in the art can combine and assemble different embodiments or examples and features of different embodiments or examples described in this specification without mutual contradiction. Although the embodiments of the present invention and their advantages have been described in detail, it should be understood that various changes, substitutions, and modifications can be made herein without departing from the scope of the patent application.

1. An ion-electron mixed conductor ceramic, characterized by comprising silver (Ag)-modified LLZTO ceramic.

2. The ion-electron mixed conductor ceramic according to claim 1, characterized in that the LLZTO is Li_{6.5}La₃Zr_{1.5}Ta_{0.5}O₁₂, Li₇La₃Zr₂O₁₂, or a doped derivative ceramic thereof.

3. A preparation method of an ion-electron mixed conductor ceramic, characterized by comprising the following steps:
Adding LLZTO ceramic into a solution containing a soluble silver salt and a reducing agent to obtain silver oxide;
Reacting the silver oxide under the action of the reducing agent to prepare the Ag-modified LLZTO ceramic.

4. The preparation method according to claim 3, characterized in that the soluble silver salt is one of silver nitrate (AgNO₃), silver chlorate (AgClO₃), and silver perchlorate (AgClO₄).

5. The preparation method according to claim 3, characterized in that the reducing agent is one of ethanol, sulfurous acid, sodium sulfite, and hydrogen peroxide.

6. A composite solid electrolyte, characterized by comprising the ion-electron mixed conductor ceramic according to any one of claims 1, a lithium salt, and a polymer.

7. The composite solid electrolyte according to claim 6, characterized in that the lithium salt is one of lithium bis(fluorosulfonyl)imide, lithium bis(trifluoromethanesulfonyl)imide, lithium hexafluorophosphate, and lithium tetrafluoroborate; the polymer is one of polyethylene oxide (PEO), polyvinylidene fluoride (PVDF), and polyvinylidene fluoride-hexafluoropropylene (PVDF-HFP).

8. A preparation method of the solid electrolyte according to claim 6, characterized by mixing the polymer, the lithium salt, and the ion-electron mixed conductor ceramic in a certain proportion uniformly to prepare the solid electrolyte.

9. A battery electrode material, characterized by comprising the ion-electron mixed conductor ceramic according to claim 1.

10. A battery, characterized by comprising the ion-electron mixed conductor ceramic according to claim 1.

11. A battery, characterized by comprising the solid electrolyte according to claim 6.
